(19) United States
(12) Patent Application Publication
(10) Pub. No.: US 2006/0152440 A1
(43) Pub. Date: Jul. 13, 2006

(54) PLASMA DISPLAY APPARATUS AND DRIVING METHOD THEREOF

(75) Inventor: Yongseok Chi, Suwon-si (KR)

Correspondence Address: FISH & RICHARDSON P.C., P.O. BOX 1022, MINNEAPOLIS, MN, 55440-1022, US

(73) Assignee: LG Electronics Inc., Youngdungpo-gu (KR)

(21) Appl. No.: 11/275,529

(22) Filed: Jan. 12, 2006

(30) Foreign Application Priority Data
Jan. 13, 2005 (KR) 10-2005-0003474

(51) Int. Cl. G09G 3/28

(52) U.S. Cl. 345/60

(57) ABSTRACT

The present invention relates to a plasma display apparatus and a driving method thereof. According to embodiments of the present invention, the plasma display apparatus and the driving method thereof apply a driving pulse and a driving erasing voltage to an electrode when power supply is blocked. The driving pulse and the driving erasing voltage have opposite polarities. On the basis of the embodiments of the present invention, an excessive state of an image quality, which often appears after power supply is blocked can be impaired, and a stable operation of the plasma display apparatus can be implemented.

This Nonprovisional application claims priority under 35 U.S.C. § 119(a) on Patent Application No. 10-2005-0003474 filed in Korea on Jan. 13, 2005, the entire contents of which are hereby incorporated by reference.

### BACKGROUND OF THE INVENTION

1. Field of the Invention

The present invention relates to a plasma display apparatus and a driving method thereof.

2. Description of the Background Art

FIG. 1 is a diagram illustrating a structure of a conventional plasma display panel. The conventional plasma display panel comprises a front panel 100 and a rear panel 110. The front panel 100 comprises a front glass substrate 101, and the rear panel 110 comprises a rear glass substrate 111. The front panel 100 and the rear panel 110 are combined together in parallel with a predetermined distance therebetween.

A sustain electrode pair is formed over the front glass substrate 101 to sustain emission of cells by reciprocal discharges. The sustain electrode pair comprises a scan electrode 102 and a sustain electrode 103. The scan electrode 102 comprises a first transparent electrode 102a and a first bus electrode 102b, and the sustain electrode 103 comprises a second transparent electrode 103a and a second bus electrode 103b. The first and second transparent electrodes 102a and 103a are formed of transparent indium tin oxide (ITO), and the first and second bus electrodes 102b and 103b are formed of a metal based material. The scan electrode 102 receives a scan pulse to scan and a sustain pulse to sustain a discharge. The sustain electrode 103 mainly receives the sustain pulse. An upper dielectric layer 104 is formed over the sustain electrode pair, and restricts discharge current and insulates the scan electrode 102 and the sustain electrode 103 from each other. A protection layer 105 is formed over the upper dielectric layer 104 and is formed of magnesium oxide (MgO) to make it easier to set up a discharge condition.

Address electrodes 113 are formed over the rear glass substrate 111 such that the address electrodes 113 across the sustain electrode pair. A lower dielectric layer 115 is formed over the address electrodes 113 and insulates the address electrodes 113 from each other. Barrier ribs 112 are formed over the lower dielectric layer 115 and partition discharge cells. A phosphor layer 114 is coated between the barrier ribs 112 and emits visible rays.

The front glass substrate 101 and the rear glass substrate 111 are sealed together using a sealing material. An inert gas such as helium (He), neon (Ne) or xenon (Xe) is injected inside the plasma display panel after an exhaust process is performed.

The conventional plasma display panel receives a driving pulse from a driving device and various control signals. A plasma display apparatus comprises the plasma display panel and the driving device.

FIG. 2 is a driving waveform view of a conventional plasma display panel. The conventional plasma display panel has a driving period divided into three parts comprising a reset period, an address period, a sustain period, and an erasing period.

The reset period is divided into a set-up period and a set-down period. During the set-up period, an ascending ramp-up pulse is simultaneously applied to scan electrodes. The ascending ramp-up pulse causes a dark discharge within discharge cells. Wall charges of a positive polarity are accumulated over address electrodes and sustain electrodes due to the dark discharge, whereas wall charges of a negative polarity are accumulated over the scan electrodes.

During the set-down period, a descending ramp-down pulse, which is dropped down to a certain voltage level below a ground level voltage (GND), erases wall charges excessively generated over the scan electrodes. A set-down discharge causes the wall charges to remain uniformly within the discharge cells.

During the address period, a scan pulse of a negative polarity Scan is sequentially applied to the scan electrodes, while an address pulse of a positive polarity Va is applied to the address electrodes. An address discharge occurs as a voltage difference between the scan pulse and the address pulse and the wall charges generated during the reset period are added together. A voltage of a positive polarity Vz is applied to the sustain electrodes to prevent an occurrence of an erroneous discharge with the scan electrodes by decreasing a voltage difference between the sustain electrodes and the scan electrodes.

During the sustain period, a sustain pulse sus is applied alternately to the scan electrodes and the sustain electrodes. As a result, a sustain discharge occurs at the discharge cells selected by the address discharge. A peak voltage level of the sustain pulse sus is a sustain voltage Vs.

After the completion of the sustain discharge, during the erasing period, a voltage of a ramp waveform Ramp-ers is supplied to the sustain electrodes to erase the wall charges remaining within the discharge cells.

While the conventional plasma display apparatus operates, even if the power supply is blocked, the driving pulses are applied continuously.

FIG. 3 is a waveform view of a driving pulse, which is continuously applied after the power supplied to a conventional plasma display panel is blocked. As illustrated, a sustain pulse is applied to scan electrodes Y continuously and unstably even after an alternating current (AC) power supply is blocked. After the AC power supply is blocked, an unstable sustain pulse of which peak voltage is a voltage V1 smaller than a sustain voltage Vs is continuously applied. Although FIG. 3 illustrates only the sustain pulse applied to the scan electrodes Y, driving pulses applied to sustain electrodes and address electrodes are applied continuously and unstably.

The sustain pulse, which is applied continuously and unstably to the scan electrodes Y after the AC power supply is blocked, and remaining wall discharges may induce an excessive state of an image quality when the AC power supply is blocked. In other words, the image quality may be deteriorated due to a logic signal applied to a driving device, which applies the sustain pulse while not being supplied with a sufficient level of the sustain voltage Vs.

Also, when the AC power starts being supplied, the driving device or a power voltage circuit may get deteriorated due to an erroneous operation of the driving device.

### SUMMARY OF THE INVENTION

Accordingly, an object of the present invention is to solve at least the problems and disadvantages of the background art.

It is an object of the present invention to provide a plasma display apparatus, which can prevent an excessive state of an image quality when power supply is blocked, and a driving method thereof.

It is another object of the present invention to provide a plasma display apparatus, which can prevent deterioration of a driving device or a power voltage circuit, and a driving method thereof.

It is a further object of the present invention to provide a plasma display apparatus, which can operation stably, and a driving method thereof.

According to a first embodiment of the present invention, a plasma display apparatus comprises a power blocking detection unit, a controller, an electrode driver, and a plasma display panel. The power blocking detection unit detects whether power supply is blocked and outputs a detection signal thereafter. The controller for outputting a control signal according to the detection signal. The electrode driver supplies a driving erasing voltage having a polarity reverse to the polarity of a driving pulse according to the control signal. The plasma display panel comprises an electrode and is applied with the driving erasing voltage through the electrode.

According to a second embodiment of the present invention, a driving method of a plasma display apparatus, which comprises an electrode, comprises determining whether power supply is blocked, outputting a detection signal when the power supply is blocked, outputting a control signal according to the detection signal and applying a driving erasing voltage erasing a driving pulse according to the control signal.

According to the exemplary embodiments of the present invention on the plasma display panel and the driving method thereof, applying the driving erasing voltage can prevent an excessive state of an image quality after the power supply is blocked.

According to the exemplary embodiments of the present invention on the plasma display panel and the driving method thereof, applying the driving erasing voltage can prevent a driving device and a power circuit from being deteriorated.

According to the exemplary embodiments of the present invention on the plasma display panel and the driving method thereof, applying the driving erasing voltage can provide a stable operation of the plasma display apparatus.

### BRIEF DESCRIPTION OF THE DRAWINGS

The invention will be described in detail with reference to the following drawings in which like numerals refer to like elements.

FIG. 1 is a diagram illustrating a structure of a conventional plasma display panel;

FIG. 2 is a waveform view of a conventional plasma display panel;

FIG. 3 is a waveform view of a driving pulse, which is continuously applied after power supplied to a conventional plasma display panel is blocked;

FIG. 4 is a block diagram illustrating a plasma display apparatus according to an embodiment of the present invention;

FIG. 5 is a diagram illustrating a power blocking detection unit according to an embodiment of the present invention;

FIGS. 6a and 6b are graphs illustrating waveforms of a sustain pulse before and after power supply is blocked;

FIG. 7 is a diagram illustrating a power blocking detection unit according to an embodiment of the present invention;

FIG. 8 is a flowchart illustrating a driving method of the plasma display apparatus according to an embodiment of the present invention;

FIG. 9a is a driving waveform view of the plasma display apparatus operating according to the embodiment of the present invention when power supply is blocked during a sustain period; and

FIG. 9b is a driving waveform view of the plasma display apparatus operating according to the embodiment of the present invention when power supply is blocked in a reset period or in an address period.

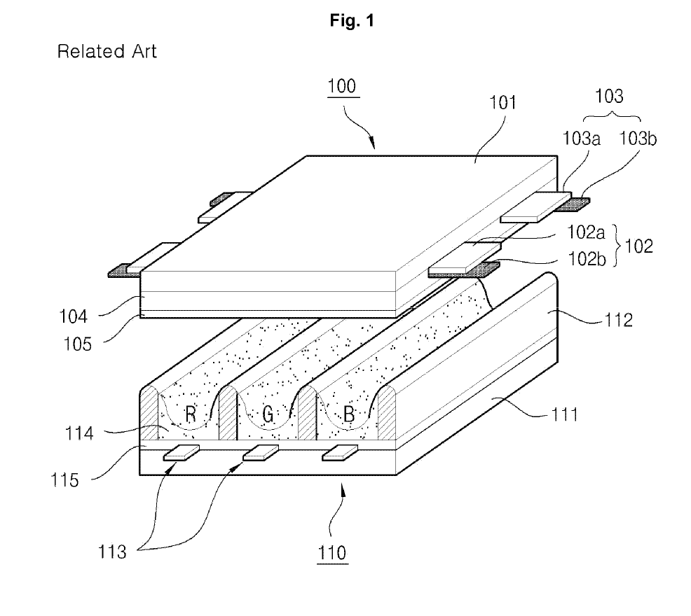

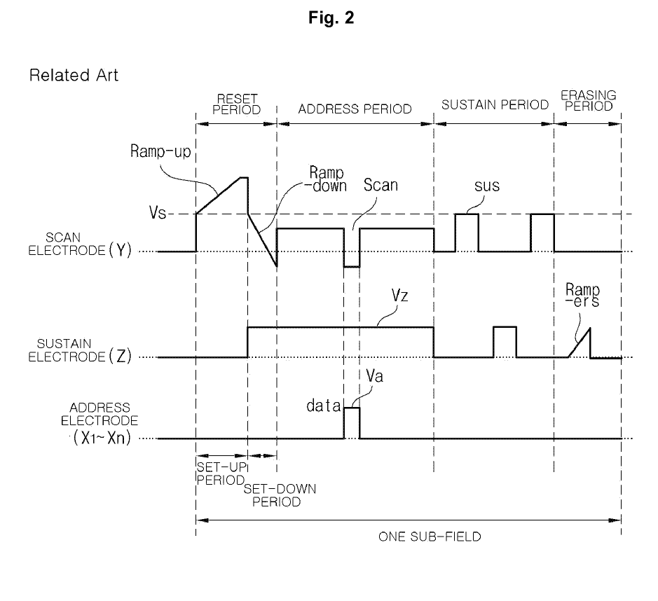

### DETAILED DESCRIPTION OF PREFERRED EMBODIMENTS

Embodiments of the present invention will be described in a more detailed manner with reference to the drawings.

A plasma display apparatus according to an embodiment of the present invention comprises a power blocking detection unit, a controller, a logic signal unit, an electrode driver, and a plasma display panel. The power blocking detection unit detects whether power supply is blocked and outputs a detection signal thereafter. The controller for outputting a control signal according to the detection signal. The electrode driver supplies a driving erasing voltage having a polarity reverse to the polarity of a driving pulse according to the control signal. The plasma display panel comprises an electrode and is applied with the driving erasing voltage through the electrode.

The plasma display apparatus further comprises a logic signal unit a logic signal for letting the electrode driver output the a driving erasing voltage according to the control signal.

The driving pulse can be a sustain pulse.

A voltage level of the driving erasing voltage can be substantially identical to a voltage level of a scan pulse applied to the electrode during an address period.

The driving erasing voltage can have a negative polarity.

The power blocking detection unit can detect the blocking of the power supply within approximately 40 ms after the power supply is blocked.

The power blocking detection unit comprises a first primary power stage, a transformer, a secondary power stage, and a power detection unit. The primary power stage converts the power into a first direct current (DC) power. The transformer converts the first DC power to a second DC power. The secondary power stage converts the second DC power to a driving voltage. The power detection unit outputs the detection signal when the power supply is blocked.

The power detection unit comprises a photo-coupler, and the photo-coupler can output a detection signal of a logic low level when the power supply is blocked.

The power blocking detection unit can further comprise a voltage dividing unit and a converter. The voltage dividing unit divides a peak voltage of the sustain pulse, and the converter converts an output voltage of the voltage dividing unit into a DC voltage and outputs the detection signal.

A driving method of a plasma display apparatus according to an embodiment of the present invention comprises determining whether power supply is blocked, outputting a detection signal when the power supply is blocked, outputting a control signal according to the detection signal and applying a driving erasing voltage erasing a driving pulse according to the control signal.

The driving method further comprises outputting a logic signal for letting the driving erasing voltage outputted according to the control signal.

The driving erasing voltage can have a polarity reverse to the polarity of the driving pulse.

The driving pulse can be a sustain pulse.

A voltage level of the driving erasing voltage can be substantially identical to a voltage level of a scan pulse applied to a scan electrode during an address period.

The driving erasing voltage can have a negative polarity.

After the power supply is blocked, the detection signal can be outputted within approximately 40 ms.

A change of voltage level in the power can be used to detect whether the power supply is blocked.

A change of voltage level in the driving pulse can be used to detect whether the power supply is blocked.

A voltage level of the driving erasing voltage can be substantially identical to the voltage level of the scan pulse applied to an electrode during an address period.

Hereinafter, the above embodiments of the present invention will be described in detail with reference to the accompanying drawings.

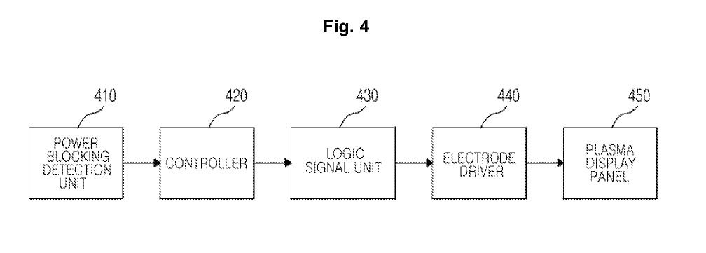

FIG. 4 is a block diagram illustrating a plasma display apparatus according to a specific embodiment of the present invention. As illustrated, the plasma display apparatus comprises a power blocking detection unit 410, a controller 420, a logic signal unit 430, an electrode driver 440, and a plasma display panel 450.

The power blocking detection unit 410 detects whether power supply to the plasma display panel 450 is blocked and outputs a detection signal.

The controller 420 outputs a control signal for controlling a logic signal according to the detection signal outputted from the power blocking detection unit 410.

The logic signal unit 430 outputs the logic signal according to the control signal outputted from the controller 420.

The electrode driver 440 applies a driving erasing voltage erasing a driving pulse according to the logic signal outputted from the logic signal unit 430. The driving erasing voltage has a polarity reverse to the polarity of the driving pulse. In the present embodiment, the driving pulse is a sustain pulse to sustain a sustain discharge, and the driving erasing pulse is a sustain status erasing voltage having a polarity reverse to the polarity of the sustain pulse.

The plasma display panel 450 comprises an electrode and is supplied with the sustain status erasing voltage from the electrode driver 440 through the electrode.

The driving erasing voltage applied by the electrode driver 440 erases remaining wall charges generated by the driving pulse. Erasing the remaining wall charges by the driving erasing voltage contributes to a stabilization of the plasma display apparatus after the power supply is blocked. As a result, an excessive state of an image quality and deterioration of a driving device and a power circuit can be impaired.

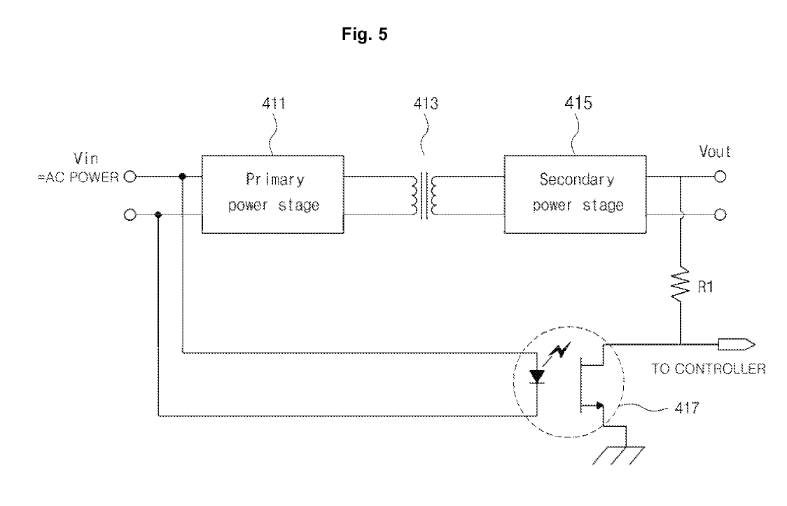

FIG. 5 is a diagram illustrating one exemplary power blocking detection unit according to the specific embodiment of the present invention. As illustrated, a primary power stage 411 of the power blocking detection unit 410 converts an AC power supplied from outside into a first DC power. A transformer 413 of the power blocking detection unit 410 converts the first DC power into a certain level of a second DC power. A secondary power stage 415 converts the second DC power into a voltage necessary for driving the plasma display panel 450 illustrated in FIG. 4. A power detection unit 417 detects whether the AC power supply is blocked, and when the power detection unit 417 detects that the AC power supply is blocked, the power detection unit 417 outputs the detection signal to the control unit 420 illustrated in FIG. 4. The power detection unit 417 comprises a photo-coupler. The photo-coupler outputs an output of the secondary power stage 415 to the controller 420. Particularly, the output of the secondary power stage 415 is descended by a resistor R1 as the AC power is supplied. When the AC power supply is blocked, the photo-coupler of the power detection unit 417 outputs a detection signal of a logic low level.

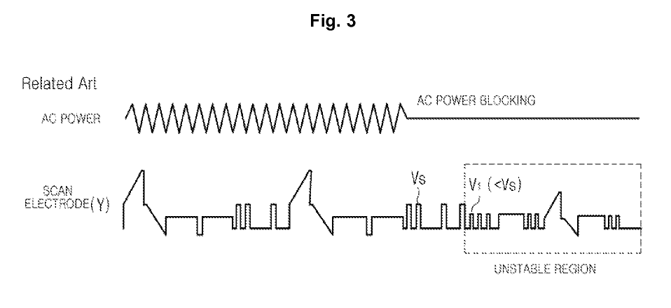

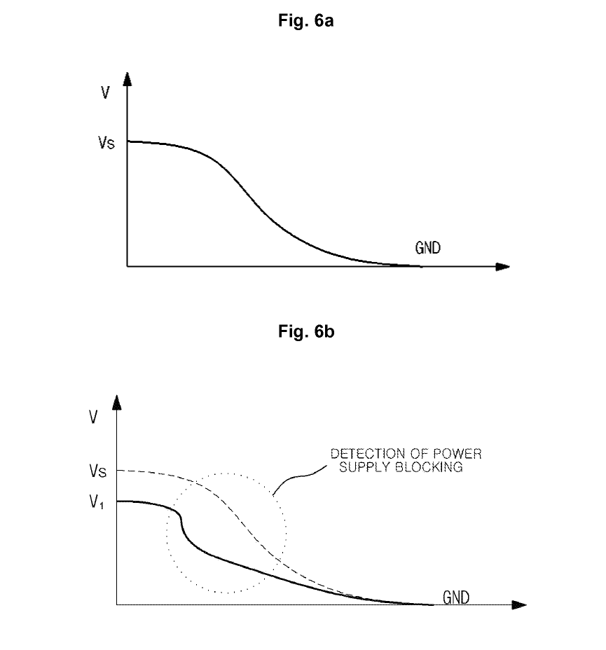

FIGS. 6a and 6b are graphs illustrating a change in waveforms of a sustain pulse before and after power supply is blocked. As illustrated in FIG. 6a, when the power is supplied, a waveform of the sustain pulse from a sustain voltage Vs to a ground level voltage GND is gradual. After the power supply is blocked, as described in FIG. 3, an unstable sustain pulse is applied to the electrode. As illustrated in FIG. 6b, an unstable sustain pulse of which peak voltage has a voltage V1 smaller than the sustain voltage Vs is continuously applied. A voltage descending occurs spontaneously from the peak voltage V1 of the sustain pulse to the ground level voltage GND.

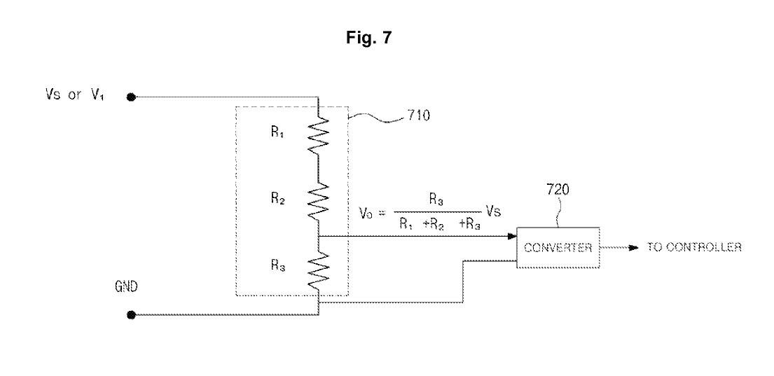

FIG. 7 is a diagram illustrating another exemplary power blocking detection unit according to the specific embodiment of the present invention. The other exemplary power blocking detection unit detects the blocking of the power supply by detecting a spontaneous voltage change of an unstable sustain pulse as illustrated in FIG. 6b. The other exemplary power blocking detection unit comprises a voltage dividing unit 710 and a converter 720.

The voltage dividing 710 comprises first to third resistors R1, R2 and R3 to divide a peak voltage Vs or V1 of the sustain pulse. As illustrated in FIG. 7, the first to third resistors R1, R and R3 can be connected in series. An output voltage V0 of the voltage dividing unit 710 in which the first to third resistors R1, R2 and R3 are connected in series is a voltage applied to the third resistor R3.

The converter 720 converts the output voltage V0 of the voltage dividing unit 710 into a DC voltage and outputs the detection signal to the controller 420 illustrated in FIG. 4.

Specifically, when an unstable sustain pulse starts being applied as the power supply is blocked, the output voltage V0 of the voltage dividing unit 710 changes spontaneously. Then, the converter 720 outputs the detection signal to the controller 420 illustrated in FIG. 4. The converter 720 checks a change in the output voltage V0 for every period of less than approximately 10 ms.

When the power supply is blocked, the above power blocking detection units illustrated in FIGS. 5 and 7 can detect the blocking of the power supply within approximately 40 ms.

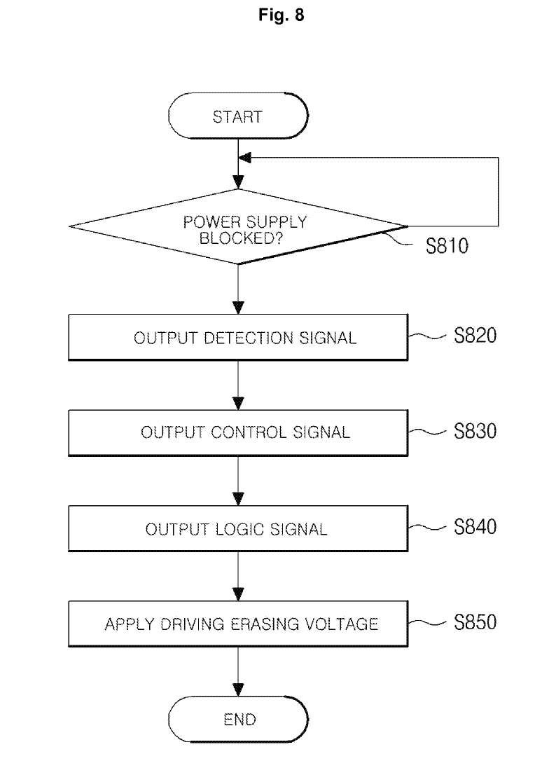

With reference to FIGS. 4 and 8, a driving method of the plasma display apparatus will be described in detail.

FIG. 8 is a flowchart illustrating the driving method of the plasma display apparatus according to the specific embodiment of the present invention.

In operation S810, the power blocking detection unit 410 determines whether power supply to the plasma display panel 450 is blocked. The power blocking detection unit 410 can directly detect a change in an AC power supplied from outside, or can detect the AC power change based on a change in a sustain pulse.

When the power blocking detection unit 410 affirms the blocking of the power supply, the power blocking detection unit 410 outputs a detection signal to the controller 420 in operation S820.

In operation S830, the controller 420 outputs a control signal for controlling a logic signal to the logic signal unit 430 according to the detection signal outputted from the power blocking detection unit 410.

In operation S840, the logic controller 430 outputs the logic signal to the electrode driver 440 according to the control signal outputted from the controller 420.

In operation S850, the electrode driver 440 applies a driving erasing voltage, which stimulates an erasing of a driving pulse, according to the logic signal outputted from the logic signal unit 430. The driving erasing pulse has a polarity reverse to the polarity of the driving pulse.

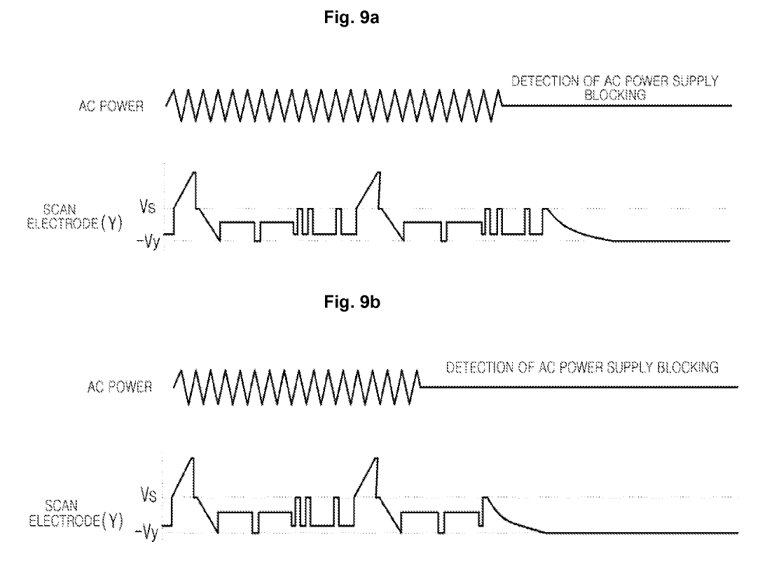

FIG. 9a is a driving waveform view of the plasma display apparatus, which operates according to the embodied driving method thereof, when the power supply is blocked in a sustain period. FIG. 9b is a driving waveform view of the plasma display apparatus, which operates according to the embodied driving method thereof, when the power supply is blocked in a reset period or in an address period.

As illustrated in FIG. 9a, when the power supply is blocked in the sustain period, the driving erasing voltage is applied to the electrode according to the exemplary embodiment on the driving method of the plasma display apparatus. Since the sustain pulse, which is a driving pulse, has a positive polarity, the driving erasing voltage has a negative polarity. As the driving erasing voltage of the negative polarity is applied to the electrode, an unstable sustain pulse, which appears after the power supply is blocked, is erased.

As illustrated in FIG. 9b, when the power supply is blocked in the reset period or in the address period, the driving erasing voltage is applied to the electrode according to the exemplary embodiment on the driving method of the plasma display apparatus.

As the driving erasing voltage of the negative polarity is applied to the electrode, the unstable sustain pulse can be erased, and the erasing of the unstable sustain pulse can further erase remaining wall charges. As a result, deterioration of a driving device or a power circuit can be impeded, and the plasma display apparatus can operate stably.

As illustrated in FIGS. 9a and 9b, when a voltage level of the driving erasing voltage applied to the electrode driver 440 illustrated in FIG. 4 is substantially identical to the voltage level of the scan pulse applied to the scan electrode in the address period, a simple configuration of the electrode driver 440 can be achieved.

The invention being thus described, it will be obvious that the same may be varied in many ways. Such variations are not to be regarded as a departure from the spirit and scope of the invention and all such modifications as would be obvious to one skilled in the art are intended to be comprised within the scope of the following claims.

What is claimed is:

1. A plasma display apparatus comprising:
a power blocking detection unit for detecting whether power supply is blocked and outputting a detection signal thereafter;
a controller for outputting a control signal according to the detection signal;
an electrode driver for supplying a driving erasing voltage having a polarity reverse to the polarity of a driving pulse according to the control signal; and
a plasma display panel comprising an electrode and applied with the driving erasing voltage through the electrode.

2. The plasma display apparatus of claim 1, wherein the plasma display apparatus further comprises a logic signal unit a logic signal for letting the electrode driver output the a driving erasing voltage according to the control signal.

3. The plasma display apparatus of claim 1, wherein the driving pulse is a sustain pulse.

4. The plasma display apparatus of claim 1, wherein a voltage level of the driving erasing voltage is substantially identical to the voltage level of a scan pulse applied to the electrode during an address period.

5. The plasma display apparatus of claim 1, wherein the driving erasing voltage has a negative polarity.

6. The plasma display apparatus of claim 1, wherein the power blocking detection unit detects the blocking of the power supply within approximately 40 ms after the power supply is blocked.

7. The plasma display apparatus of claim 1, wherein the power blocking detection unit comprises:
a primary power stage for converting the power into a first direct current (DC) power;
a transformer for transforming the first DC power into a second DC power;
a secondary power stage for converting the second DC power into a driving voltage; and
a power detection unit for outputting the detection signal when the power supply is blocked.

8. The plasma display apparatus of claim 7, wherein the power detection unit comprises a photo-coupler for outputting a detection signal of a logic low level when the power supply is blocked.

9. The plasma display apparatus of claim 1, wherein the power blocking detection unit comprises:
a voltage dividing unit for dividing a peak voltage of a sustain pulse; and
a converter for converting an output voltage of the voltage dividing unit into a DC voltage and then for outputting the detection signal.

10. A driving method of a plasma display apparatus comprising an electrode, the driving method comprising:
determining whether power supply is blocked;
outputting a detection signal when the power supply is blocked;
outputting a control signal according to the detection signal; and
applying a driving erasing voltage erasing a driving pulse according to the control signal.

11. The driving method of claim 10, wherein the driving method further comprises outputting a logic signal for letting the driving erasing voltage outputted according to the control signal.

12. The driving method of claim 10, wherein the applying of the driving erasing voltage comprises applying the driving erasing voltage having a polarity reverse to the polarity of the driving pulse.

13. The driving method of claim 10, wherein in the applying of the driving erasing voltage, the driving pulse is a sustain pulse.

14. The driving method of claim 10, wherein a voltage level of the driving erasing voltage substantially identical to the voltage level of a scan pulse applied to a scan electrode during an address period.

15. The driving method of claim 10, wherein the applying of the driving erasing voltage comprises applying the driving erasing voltage having a negative polarity.

16. The driving method of claim 10, wherein the outputting of the detection signal comprises outputting the detection signal within approximately 40 ms after the power supply is blocked.

17. The driving method of claim 10, wherein the determining whether the power supply is blocked comprises detecting a change of voltage level in the power.

18. The driving method of claim 10, wherein the determining whether the power supply is blocked comprises detecting a change of voltage level in the driving pulse.

19. The driving method of claim 10, wherein a voltage level of the driving erasing voltage is substantially identical to the voltage level of a scan pulse applied to the electrode during an address period.
